(19) United States
(12) Patent Application Publication
(10) Pub. No.: US 2026/0321957 A1
(43) Pub. Date: Oct. 15, 2026

(54) SELF-CENTERING WAVEGUIDE CLAMP ANTENNA MOUNT

(71) Applicant: Government of the United States of America, as represented by the Secretary of Commerce, Gaithersburg, MD (US)

(72) Inventors: Benjamin Luke Moser, Golden, CO (US); Joshua Ari Gordon, Lafayette, CO (US)

(21) Appl. No.: 19/635,852

(22) Filed: Apr. 1, 2026

Related U.S. Application Data
(60) Provisional application No. 63/787,397, filed on Apr. 11, 2025.

(51) Int. Cl. H01Q 1/12; H01Q 13/02

(52) U.S. Cl. CPC H01Q 1/1207; H01Q 13/02

(57) ABSTRACT

A self-centering waveguide clamp antenna mount includes a mounting surface defining a mounting coordinate system. A centering mechanism is coupled to the mounting surface, and the centering mechanism includes opposing screw threads. Offset arms are connected to the centering mechanism and extend outwardly therefrom. Gripper jaws are connected to the offset arms. The gripper jaws have interlocking finger features. The gripper jaws further include at least one axis of rotation substantially perpendicular to an axis of motion generated by the centering mechanism. The interlocking finger features of the gripper jaws are configured to accommodate a plurality of waveguide geometries and sizes.

### CROSS-REFERENCE TO RELATED APPLICATION

This application claims the benefit of U.S. Provisional Patent Application Ser. No. 63/787,397 (filed Apr. 11, 2025), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of antenna mounts, and more particularly to techniques for precisely and repeatably positioning antennas and waveguides of varying geometries.

The precise positioning and alignment of antennas, particularly those connected to waveguides, are critical in a wide array of applications, ranging from radio frequency (RF) system development and metrology to communications, aerospace, defense, manufacturing, and automotive industries. Accurate antenna positioning is paramount for ensuring reliable measurements, system performance, and interoperability. Existing methods for mounting antennas, however, often present significant limitations, hindering efficiency and accuracy. These legacy approaches often involve custom-machined fixtures or proprietary mounting schemes, which can be time-consuming and costly to implement, and may not be easily adaptable to varying antenna geometries or waveguide sizes.

A common practice in the prior art involves the use of interface plates bonded directly to the antenna. These plates, in conjunction with standoffs (such as threaded rods), connect the antenna to a final mount plate. While this approach provides some degree of adjustability in antenna orientation by manipulating the standoffs, it offers limited precision control over the complete spatial location of the antenna. Furthermore, proprietary mounting solutions often necessitate the creation of corresponding mounting patterns, which may be incompatible with existing equipment, such as robotic antenna ranges, due to the long moment arms required by these specialized solutions. This lack of standardization and the need for bespoke components for different antenna configurations significantly increase setup time and complexity, especially in environments where diverse antenna types are regularly tested and calibrated. The time lost in configuring and reconfiguring mounting systems, sometimes extending to weeks, represents a substantial bottleneck.

The inherent inflexibility of current solutions poses significant challenges in research and development, as well as in calibration and testing facilities. Consider, for example, a facility like the NIST LAPS antenna range, where reducing setup time even by a few days could translate into significant cost savings and improved operational efficiency. Commercially available products for holding waveguides are frequently limited to rigid clamps, unadjustable for varying waveguide sizes, or require custom machining. This lack of adaptability, along with the absence of precise torquing mechanisms for consistent and repeatable clamping forces, further compounds the difficulties faced by engineers and technicians. The inefficiencies of a technician having to make a custom mount every single time are cumulative. The iterative process of alignment and the potential for inconsistencies introduce further errors and delays.

It is therefore an objective of the present invention to provide a versatile, self-centering antenna mount that accommodates a wide range of waveguide and antenna geometries without requiring custom-machined components or significant modifications to the antenna itself, thereby overcoming the above-mentioned disadvantages of the prior art at least in part. This solution should also facilitate rapid and repeatable positioning, reducing setup time and improving measurement accuracy in various antenna testing and calibration applications. Accordingly, methods and equipment for self-centering and rapidly adaptable antenna mounting would be advantageous and would be favorably received in the art.

### BRIEF DESCRIPTION

One aspect of the present invention relates to a self-centering waveguide clamp antenna mount. A waveguide, in the context of electromagnetic transmission, is a physical structure that guides electromagnetic waves, typically in the microwave or radio frequency spectrum. A clamp is a fastening device used to hold or secure objects tightly together. An antenna mount is a structure designed to support and position an antenna.

It may be provided that the self-centering waveguide clamp antenna mount includes a mounting surface defining a mounting coordinate system. A mounting surface, in this context, can be understood as a plane or a specifically designated area on a structure where the antenna mount is affixed. The “mounting coordinate system” establishes a reference frame, typically three-dimensional, relative to which the position and orientation of the antenna can be precisely defined. One advantage of this arrangement is that it provides a standardized and known reference point for antenna positioning, which is crucial for repeatable measurements and accurate alignment within a larger system, such as a robotic antenna range. The defined coordinate system directly contributes to improved accuracy and reliability in antenna testing and calibration.

It may be further provided that the mount includes a centering mechanism coupled to the mounting surface, wherein the centering mechanism includes opposing screw threads. A “centering mechanism” generally refers to a device that acts to bring an object to a central or aligned position. The inclusion of “opposing screw threads” suggests a mechanism, such as a vise or a screw-driven system, where the rotation of a screw causes two elements to move simultaneously towards or away from a central point. This arrangement ensures that the clamping force is applied symmetrically, contributing to the self-centering function of the mount. The precise and balanced force application enhances the stability and repeatability of the antenna positioning.

The mount may also comprise offset arms connected to the centering mechanism and extending outwardly therefrom. “Offset arms” serve as intermediary components that provide a spatial separation between the centering mechanism and the point where the antenna or waveguide is held. This outward extension is a design choice that offers several advantages. The offset arms prevent physical interference between the clamped waveguide and the mounting surface. This allows for greater flexibility in the size and shape of antennas and waveguides that can be accommodated.

It is provided the antenna mount includes gripper jaws connected to the offset arms, the gripper jaws having interlocking finger features, wherein the gripper jaws further comprise at least one axis of rotation substantially perpendicular to an axis of motion generated by the centering mechanism, and wherein the interlocking finger features of the gripper jaws are configured to accommodate a plurality of waveguide geometries and sizes. “Gripper jaws” are the components that directly contact and hold the antenna or waveguide. The “interlocking finger features” enable a secure grip on various shapes, ensuring versatility. The provision of at least one axis of rotation, perpendicular to the motion of the centering mechanism, allows the gripper jaws to adapt to different orientations of the waveguide, accommodating variations in antenna design. Further, the configuration to handle a plurality of waveguide geometries and sizes enhances adaptability. This eliminates the need for custom fixtures for each antenna.

One aspect of the present invention relates to a process for self-centered clamping of an antenna waveguide with a self-centering waveguide clamp antenna mount. “Self-centered clamping” implies a method where the act of clamping itself automatically aligns the object being clamped, in this case, an antenna waveguide, to a central or predetermined position.

It may be provided that the process includes providing a self-centering waveguide clamp antenna mount. This mount comprises: a mounting surface; a centering mechanism coupled to the mounting surface; offset arms connected to the centering mechanism; and gripper jaws connected to the offset arms, the gripper jaws having interlocking finger features.

It may then be provided that the process includes opening the centering mechanism to rotate the gripper jaws and create a space for receiving an antenna waveguide. “Opening the centering mechanism” refers to the act of actuating the mechanism, likely by turning a screw or similar component, in a manner that increases the distance between the gripper jaws. The explicit mention of “rotate the gripper jaws” indicates that this opening action involves a rotational movement of the jaws, enabled by the previously mentioned axis of rotation. One advantage of this step is that it prepares the apparatus for receiving the antenna waveguide in a controlled and defined manner, setting the stage for the self-centering action.

The next step in the process may include inserting the antenna waveguide into the space between the gripper jaws. “Inserting” includes placing the waveguide within the opened gripper jaws. The advantage of this seemingly straightforward step, when performed in conjunction with the other steps and the specific design of the mount, is that it positions the waveguide for the subsequent self-centering clamping action.

Finally, it may be provided that the process involves closing the centering mechanism to clamp the antenna waveguide with the gripper jaws, wherein the interlocking finger features of the gripper jaws center the antenna waveguide along a desired axis. “Closing the centering mechanism” is the reverse of the opening step and involves actuation that brings the gripper jaws together. “Clamp the antenna waveguide” signifies the application of force by the gripper jaws to securely hold the waveguide. The “interlocking finger features,” due to their geometry and the symmetrical force applied by the centering mechanism, center the waveguide. This centering occurs along a “desired axis,” which is predetermined by the design of the mount and its coordinate system. One advantage of this step is that it achieves precise, repeatable, and self-centering alignment of the antenna waveguide, which is fundamental for accurate measurements and system performance. This eliminates the need for manual adjustments and ensures consistent positioning across multiple uses and different waveguide sizes.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings.

FIG. 1 shows, according to some embodiments, a self-centering antenna clamp mechanism, illustrating the overall arrangement of the mounting surface, centering vise or mechanism, offset arm, and centering gripper mechanism.

FIG. 2 shows, according to some embodiments, a detailed view of the centering gripper mechanism, highlighting the gripper fingers, gripper mounting component, and finger axis of rotation.

FIG. 3 shows, according to some embodiments, the interlocking finger detail of the gripper, indicating the finger gap offset distance, finger width, and gripper backer dimension.

FIG. 4 shows, according to some embodiments, the gripper alignment detail for a variety of waveguide profiles, demonstrating how the gripper fingers can support rectangular, square, circular, or oval shapes while maintaining Z-axis alignment, without compensation for rotation induced by clamping.

FIG. 5 shows, according to some embodiments, a gripper modification to support tapered waveguide or antenna profiles, incorporating a secondary rotation point to maintain alignment along the desired Z-axis.

FIG. 6 shows, according to some embodiments, a horizontal mounting variation where the grippers are positioned such that the axis of rotation is aligned with the mounting surface, resulting in an offset waveguide alignment.

FIG. 7 shows, according to some embodiments, a constrained alignment variation, incorporating mechanical constraints to eliminate the angle induced on the clamped waveguide, albeit with increased mechanical complexity.

FIG. 8 shows, according to some embodiments, examples of constrained waveguide clamping, demonstrating the ability of this variant to support various waveguide shapes while maintaining alignment with the mounting coordinate system.

FIG. 9 shows, according to some embodiments, a perspective view of a self-centering waveguide clamp antenna mount configured for vertical centering clamping mechanism placement.

FIG. 10 shows, according to some embodiments, another perspective view of the self-centering waveguide clamp antenna mount for vertical centering clamping, as shown in FIG. 9.

FIG. 11 shows, according to some embodiments, a perspective view of a self-centering waveguide clamp antenna mount for horizontal clamping mechanism placement.

FIG. 12 shows, according to some embodiments, another perspective view of the self-centering waveguide clamp antenna mount for horizontal clamping, as shown in FIG. 11.

### DETAILED DESCRIPTION

A detailed description of one or more embodiments is presented herein by way of exemplification and not limitation.

Conventional antenna mounting solutions often suffer from several technical deficiencies. Many existing systems rely on custom-machined fixtures or proprietary mounting schemes that are specific to particular antenna geometries and waveguide sizes. This necessitates the fabrication of new mounting hardware for each different antenna or waveguide, leading to significant delays and increased costs. Furthermore, these conventional approaches often lack precise adjustability, making it difficult to achieve accurate and repeatable antenna positioning, which is crucial for reliable measurements and system performance. Adjustments, when possible, are typically made manually, introducing the potential for human error and inconsistencies. The lack of a standardized, self-centering mechanism in many existing systems also means that aligning antennas of different dimensions can be a time-consuming and iterative process.

The self-centering waveguide clamp antenna mount described herein overcomes these limitations of conventional antenna mounting solutions. It has been discovered that a self-centering waveguide clamp antenna mount provides a versatile and efficient solution for securely holding and precisely positioning antennas and waveguides of varying geometries and sizes.

One advantage of the self-centering waveguide clamp antenna mount is its ability to accommodate a wide range of antenna and waveguide configurations without requiring custom-machined components. This is achieved through the use of gripper jaws (4) with interlocking finger features, which can adapt to different shapes and sizes. This eliminates the need for antenna-specific mounting hardware, significantly reducing setup time and costs. Another advantage is the precise and repeatable positioning afforded by the centering mechanism (2) and the defined mounting coordinate system on the mounting surface (1). The centering mechanism (2), with its opposing screw threads, ensures symmetrical force application, while the mounting coordinate system provides a known reference frame. This combination allows for accurate alignment of the antenna waveguide along a desired axis, improving measurement accuracy and consistency. The inclusion of offset arms (3) further enhances the versatility of the mount by preventing physical interference between the clamped waveguide and the mounting surface (1), accommodating larger and more complex antenna designs. The at least one axis of rotation in the gripper jaws (4), being substantially perpendicular to the axis of motion from the centering mechanism (2), further enhances adaptability to a plurality of waveguide geometries.

In an embodiment, a self-centering waveguide clamp antenna mount comprises: a mounting surface (1) defining a mounting coordinate system; a centering mechanism (2) coupled to the mounting surface (1), wherein the centering mechanism (2) includes opposing screw threads; offset arms (3) connected to the centering mechanism (2) and extending outwardly therefrom; and gripper jaws (4) connected to the offset arms (3), the gripper jaws (4) having interlocking finger features, wherein the gripper jaws (4) further comprise at least one axis of rotation substantially perpendicular to an axis of motion generated by the centering mechanism (2), and wherein the interlocking finger features of the gripper jaws (4) are adjustably reconfigurable to accommodate a plurality of waveguide geometries and sizes. In an embodiment, the mounting surface (1) is an end effector flange of a robotic arm. In an embodiment, the centering mechanism (2) is a vise. In an embodiment, the offset arms (3) are machined plates. In an embodiment, the gripper jaws (4) comprise a plurality of interlocking fingers, and wherein a gap (8) between adjacent fingers on one of the gripper jaws (4) is larger than a width (9) of a corresponding finger on an opposing gripper jaw (4). In an embodiment, the gripper jaws (4) are configured to grasp waveguides having rectangular, square, circular, or oval cross-sectional shapes. In an embodiment, the gripper jaws (4) further include a secondary rotation point (11) configured to accommodate tapered waveguide profiles, wherein an axis of rotation of the secondary rotation point (12) is perpendicular to a clamping direction of the gripper jaws (4). In an embodiment, the at least one axis of rotation of the gripper jaws (4) is aligned with the mounting surface (1). In an embodiment, the self-centering waveguide clamp further comprises: linear motion constraints (15, 17) coupled to the mounting surface (1) and the offset arms (3) respectively, the linear motion constraints (15,17) are configured to restrict movement of the offset arms (3) to a linear path; and wherein the gripper jaws (21) are statically mounted to the offset arms (3) without rotation. In an embodiment, the linear motion constraints are linear rails (15,17).

The self-centering waveguide clamp antenna mount comprises several elements working in concert to achieve its functionality. The first element is the mounting surface (1), which defines a mounting coordinate system. Functionally, the mounting surface (1) serves as the foundational element to which the entire assembly is attached. It provides a stable and defined reference point for positioning the antenna. The mounting coordinate system, established on this surface, is crucial for precisely determining the antenna's location and orientation in three-dimensional space. Implementation of the mounting surface (1) can vary and can be a flat plate, a flange designed for connection to a robotic arm, or any other rigid structure capable of providing a stable base. The benefits include providing a known and repeatable reference, which is essential for accurate measurements and consistent alignment in applications like antenna testing. Variations could include different shapes or materials, depending on the specific application requirements. For instance, the mounting surface (1) could be adapted to interface with various positioning systems or test environments.

The centering mechanism (2), coupled to the mounting surface (1), includes opposing screw threads. Functionally, the centering mechanism (2) is responsible for applying a symmetrical clamping force. The opposing screw threads ensure that as the mechanism is tightened, the attached components move equally towards a central point. This implementation could take the form of a vise, a screw-driven system, or other mechanisms employing opposing threads. The benefit is the automatic centering of the clamped object, eliminating the need for manual adjustments and ensuring precise alignment. Variations can include different thread pitches for finer or coarser control, and alternative mechanisms like hydraulic or pneumatic actuators could be considered although screw threads offer simplicity and precision. In practice, an engineer might use a torque wrench to tighten the centering mechanism (2) to a specific value, ensuring consistent clamping force.

Offset arms (3) are connected to the centering mechanism (2) and extend outwardly therefrom. Functionally, the offset arms (3) provide spatial separation between the centering mechanism (2) and the gripper jaws (4). This separation is to prevent physical interference between the clamped waveguide and the mounting surface (1) or other parts of the assembly. The implementation often involves rigid, machined plates although materials like aluminum extrusions or strong polymers could be used. The benefit is the ability to accommodate a wider range of waveguide and antenna sizes and shapes without collision. Variations could include different lengths or shapes of the offset arms (3) to customize the working space. For example, an application requiring the mounting of a large horn antenna might utilize longer offset arms (3) to provide adequate clearance.

The gripper jaws (4) are connected to the offset arms (3) and feature interlocking finger features. The gripper jaws (4) are responsible for directly grasping and holding the antenna waveguide. The interlocking finger features allow the jaws to conform to various waveguide geometries, providing a secure grip. The gripper jaws (4) also incorporate at least one axis of rotation that is substantially perpendicular to the axis of motion created by the centering mechanism (2). This design allows the jaws to adapt to different orientations of the waveguide. The implementation could involve precision-machined fingers with specific clearances and pivot points. The benefits are numerous: versatility in accommodating various waveguide shapes (rectangular, square, circular, oval), secure grip, and adaptable orientation. Variations might include different finger geometries or the addition of a secondary rotation point for tapered waveguides. A specific use case could involve clamping a rectangular waveguide, where the interlocking fingers would securely engage the waveguide's sides, and the axis of rotation would allow for adjustments to the waveguide's angle. The configuration to accommodate a plurality of waveguide geometries and sizes eliminates time consuming tasks for technicians, such as creating a customized mount.

The mounting surface (1) can be specifically implemented as an end effector flange of a robotic arm. Functionally, this allows the self-centering waveguide clamp antenna mount to be directly integrated with robotic positioning systems, enabling automated antenna manipulation and measurement. The implementation involves designing the mounting surface (1) with a bolt pattern or other interface that is compatible with standard robotic arm end effectors. The benefit is seamless integration with automated testing and calibration setups, significantly improving efficiency and repeatability. Variations could include adapters for different robotic arm models. An example of use would be mounting the clamp to a robotic arm in an anechoic chamber for automated antenna pattern measurements.

The centering mechanism (2) may be a vise. Functionally, a vise provides a simple and robust mechanism for applying a linear clamping force using opposing screw threads. Implementation involves a standard vise, potentially modified with custom jaws or mounting features. The benefits are ease of use, readily availability, and reliable clamping force. Alternatives could include custom-designed screw mechanisms or even hydraulic or pneumatic actuators, but a vise offers a cost-effective and proven solution.

The offset arms (3) can be realized as machined plates. Functionally, machined plates provide the required rigidity and precision to maintain accurate alignment between the centering mechanism (2) and the gripper jaws (4). Implementation involves machining the plates from a suitable material, such as aluminum or steel, to precise dimensions. The benefits include high stiffness, dimensional accuracy, and durability. Alternatives could include other fabrication methods, such as casting or 3D printing, but machining generally offers precision for this application.

The gripper jaws (4) may comprise a plurality of interlocking fingers, and wherein a gap (8) between adjacent fingers on one of the gripper jaws (4) is larger than a width (9) of a corresponding finger on an opposing gripper jaw (4). Functionally, this specific geometry ensures that the fingers interlock correctly and can accommodate a range of waveguide sizes. The implementation involves precisely machining the fingers with the specified gap (8) and width (9) dimensions. The benefit is the ability to securely grip waveguides of different sizes without requiring jaw changes. Variations could involve different finger geometries or materials for specialized applications.

The gripper jaws (4) can be configured to grasp waveguides having rectangular, square, circular, or oval cross-sectional shapes. Functionally, this versatility expands the range of antennas and waveguides that can be accommodated by the mount. Implementation is achieved through the careful design of the interlocking finger geometry. The benefit is a single mount capable of handling diverse waveguide types, eliminating the need for multiple, specialized fixtures.

The gripper jaws (4) may include a secondary rotation point (12) to accommodate tapered waveguide profiles with the axis of rotation of this secondary rotation point (12) being perpendicular to the clamping direction. Functionally, this allows the mount to securely grip waveguides that are not uniform in cross-section. Implementation involves adding a second pivot point to each gripper jaw (4), allowing it to rotate and conform to the taper. The benefit is the ability to handle a wider variety of waveguide designs, including those commonly used in certain antenna types.

The at least one axis of rotation of the gripper jaws (4) may be aligned with the mounting surface (1). Functionally, this configuration results in the clamped waveguide being aligned to an offset location rather than the mounting surface's Z-axis. The benefit of this arrangement is the flexibility in positioning, allowing for different mounting orientations depending on the specific application needs.

The self-centering waveguide clamp may further include linear motion constraints (15,17) and gripper jaws (21) statically mounted on offset arms (5) without rotation. The linear motion constraints (15,17) coupled to the mounting surface (1) and the offset arms (3), Functionally restrict movement to a linear path. Implementation is achieved by attaching linear motion constraints (15,17) that are configured and arranged to constrain motion to be along a substantially linear path. The benefit of this arrangement is eliminating the angle introduced.

The linear motion constraints can take the form of linear rails (15,17). Functionally, linear rails provide a low-friction, high-precision way to guide the movement of the offset arms (3). Implementation involves attaching linear rails to the mounting surface (1) and the offset arms (3). The benefit is precise and repeatable linear motion, ensuring accurate alignment of the waveguide. Alternatives might involve other types of linear bearings or custom-designed sliding mechanisms.

In an embodiment, a process for self-centered clamping of an antenna waveguide with a self-centering waveguide clamp antenna mount includes: providing a self-centering waveguide clamp antenna mount, the mount comprising: a mounting surface (1); a centering mechanism (2) coupled to the mounting surface (1); offset arms (3) connected to the centering mechanism (2); and gripper jaws (4) connected to the offset arms (3), the gripper jaws (4) having interlocking finger features; opening the centering mechanism (2) to rotate the gripper jaws (4) and to create a space for receiving an antenna waveguide; inserting the antenna waveguide into the space between the gripper jaws (4); and closing the centering mechanism (2) to clamp the antenna waveguide with the gripper jaws (4), wherein the interlocking finger features of the gripper jaws (4) center the antenna waveguide along a desired axis. In an embodiment, the mounting surface (1) is an end effector flange of a robotic arm. In an embodiment, the process further comprises characterizing a length offset of a device under test (DUT) when a Z reference collar is used. In an embodiment, the process further comprises mechanically abutting a Z reference collar of the antenna waveguide to the self-centering waveguide clamp antenna mount. In an embodiment, the process further comprises characterizing a Z offset between a coordinate system of a device under test (DUT) and a coordinate system of a motion platform when a Z reference collar is not used. In an embodiment, closing the centering mechanism (2) comprises applying a predetermined clamping force using a torque wrench. In an embodiment, the gripper jaws (4) further include a secondary rotation point (12), and the process further comprises adjusting the secondary rotation point (12) to accommodate a tapered profile of the antenna waveguide. In an embodiment, the self-centering waveguide clamp further comprises linear motion constraints (15,17), and wherein closing the centering mechanism (2) comprises moving the offset arms (3) along a linear path defined by the linear motion constraints (15,17). In an embodiment, opening the centering mechanism (2) includes rotating the gripper jaws (4) upward. In an embodiment, the process further comprises: mounting the self-centering waveguide clamp antenna mount to an antenna positioning system prior to opening the centering mechanism (2).

The process for self-centered clamping of an antenna waveguide with a self-centering waveguide clamp antenna mount involves a series of steps that leverage the unique design of the mount. The first step is providing a self-centering waveguide clamp antenna mount. This mount, as previously detailed, comprises a mounting surface (1), a centering mechanism (2) coupled to the mounting surface (1), offset arms (3) connected to the centering mechanism (2), and gripper jaws (4) connected to the offset arms (3), with the gripper jaws (4) having interlocking finger features. Functionally, “providing” in this context means making the described apparatus available for use. The implementation relies on the physical construction of the mount.

The next step involves opening the centering mechanism (2) to rotate the gripper jaws (4) and create a space for receiving an antenna waveguide. Functionally, this step prepares the mount to accept the waveguide. The implementation involves manually turning a screw or other actuating component of the centering mechanism (2), which, due to the opposing screw threads and the connection to the offset arms (3), causes the gripper jaws (4) to move apart and rotate upwards. The benefit is the creation of a clear and accessible space for the waveguide, facilitating easy insertion. Alternatives could include using automated actuators to open the mechanism.

Subsequently, the process includes inserting the antenna waveguide into the space between the gripper jaws (4). Functionally, this positions the waveguide for clamping. Implementation is a manual step, placing the waveguide within the opened jaws. The benefit is the precise positioning relative to the gripper jaws (4) for the subsequent self-centering action.

Thereafter, the process includes closing the centering mechanism (2) to clamp the antenna waveguide with the gripper jaws (4), wherein the interlocking finger features of the gripper jaws (4) center the antenna waveguide along a desired axis. Functionally, the centering mechanism (2) is closed (e.g., by turning a screw), wherein the opposing screw threads cause the offset arms (3) and attached gripper jaws (4) to move towards each other. The interlocking finger features of the gripper jaws (4) engage the waveguide, and due to their geometry and the symmetrical force application, they automatically center the waveguide along a predetermined axis defined by the mount's design. The implementation leverages the mechanical design of the centering mechanism (2) and the gripper jaws (4). The benefit is precise, repeatable, and automatic alignment of the waveguide, eliminating the need for manual adjustments and ensuring consistent positioning. Variations could involve different clamping force profiles.

When the mounting surface (1) is an end effector flange of a robotic arm, the process benefits from the automation and precision offered by robotic positioning systems. The functionality is that the entire clamping process can be controlled and monitored robotically, allowing for highly repeatable and accurate antenna positioning. Implementation involves programming the robotic arm to execute the necessary movements for opening the centering mechanism (2), inserting the waveguide, and closing the mechanism. The benefits include increased efficiency, reduced human error, and the ability to perform complex, automated measurement sequences.

Characterizing a length offset of a device under test (DUT) when a Z reference collar is used adds a calibration step to the process. The functionality is to precisely determine the distance between a reference point on the DUT (the Z reference collar) and a known point on the mount. Implementation might involve using precision measurement tools, such as calipers or a coordinate measuring machine (CMM). The benefit is increased accuracy in determining the DUT's position, which is crucial for precise measurements.

Mechanically abutting a Z reference collar of the antenna waveguide to the self-centering waveguide clamp antenna mount provides a physical reference for positioning. Functionally, this ensures that the waveguide is inserted to a consistent depth. Implementation involves carefully pushing the waveguide into the gripper jaws (4) until the Z reference collar makes contact with a designated surface on the mount. The benefit is repeatable Z-axis positioning, eliminating variations in insertion depth.

Characterizing a Z offset between a coordinate system of a device under test (DUT) and a coordinate system of a motion platform when a Z reference collar is not used addresses situations where a physical reference is unavailable. The functionality is to establish the relative position of the DUT in the absence of a Z reference collar. Implementation could involve using optical measurement techniques or other non-contact sensing methods. The benefit is maintaining accuracy even when dealing with DUTs that lack a defined Z reference.

Applying a predetermined clamping force using a torque wrench during the closing of the centering mechanism (2) ensures consistent and controlled gripping. The functionality is to prevent over-tightening or under-tightening, which could damage the waveguide or result in slippage. Implementation involves using a calibrated torque wrench set to the appropriate torque value for the specific waveguide material and size. The benefit is repeatable clamping force, protecting the waveguide and ensuring reliable measurements.

Adjusting the secondary rotation point (3) to accommodate a tapered profile of the antenna waveguide, when the gripper jaws (4) include such a feature, allows for secure clamping of non-uniform waveguides. The functionality is to ensure that the gripper jaws (4) make full contact with the tapered surface. Implementation involves manually adjusting the secondary rotation point (3) until the jaws align with the taper. The benefit is increased versatility in handling a wider range of waveguide designs.

Moving the offset arms (3) along a linear path defined by the linear motion constraints (15,17), when such constraints are present, ensures precise and controlled closing of the centering mechanism (2). The functionality is to eliminate any unwanted lateral movement or rotation during clamping. Implementation relies on the presence of linear rails or other linear guiding mechanisms. The benefit is improved alignment accuracy and repeatability.

Rotating the gripper jaws (4) upward during the opening of the centering mechanism (2) facilitates easier insertion of the waveguide. The functionality is to provide a clear path for the waveguide, preventing any obstruction. The Implementation involves the specific design of the centering mechanism (2) and its interaction with the gripper jaws (4), such that opening the mechanism causes the jaws to rotate upwards. The benefit is improved usability and reduced risk of damaging the waveguide during insertion.

Mounting the self-centering waveguide clamp antenna mount to an antenna positioning system prior to opening the centering mechanism (2) establishes a stable and defined reference frame for the entire process. Functionally, this ensures that all subsequent actions are performed relative to a known position. The implementation involves securely attaching the mount to the positioning system, which could be a robotic arm, a test bench, or other suitable platform. The benefit is improved accuracy and repeatability of the entire clamping and positioning process.

In an embodiment, a process for making a self-centering waveguide clamp antenna mount includes: designing gripper jaws (4) with interlocking finger features, wherein a gap (8) between adjacent fingers on one of the gripper jaws (4) is greater than a width (9) of a corresponding finger on an opposing gripper jaw (4); fabricating a mounting surface (1); fabricating a centering mechanism (2) configured to apply force on attached elements in a linear manner; fabricating offset arms (3); fabricating the gripper jaws (4); attaching the centering mechanism (2) to the mounting surface (1); attaching the offset arms (3) to the centering mechanism (2); and attaching the gripper jaws (4) to the offset arms (3), wherein the gripper jaws (4) are configured with at least one axis of rotation substantially perpendicular to an axis of motion produced by the centering mechanism (2). In an embodiment, fabricating the mounting surface (1) comprises providing an adapter plate for mounting the self-centering waveguide clamp antenna mount to a robot end effector flange. In an embodiment, designing the gripper jaws (4) includes minimizing an offset between a pivot location of the gripper jaws (4) and an intersection between gripper planes. In an embodiment, fabricating the components comprises precision machining. In an embodiment, fabricating the components comprises additive manufacturing. In an embodiment, designing the gripper jaws (4) further includes designing a secondary rotation point (12) on each gripper jaw (4), the secondary rotation point (12) having an axis of rotation perpendicular to a clamping direction. In an embodiment, the process further comprises: designing linear motion constraints (15,17); fabricating the linear motion constraints 15,17); and attaching the linear motion constraints (2, 4) to the mounting surface (1) and the offset arms (3) respectively, wherein the linear motion constraints (15,17) are configured and arranged to constrain motion of the offset arms (3) to be along a substantially linear path. In an embodiment, the process further comprises attaching the gripper jaws (21) to the offset arms (3) without rotation. In an embodiment, designing clamping components further comprises designing a relief cut (10) between the grippers. In an embodiment, the centering mechanism (2) includes opposing screw threads.

The process for making a self-centering waveguide clamp antenna mount involves a series of design and fabrication steps. The process involves designing gripper jaws (4) with interlocking finger features, wherein a gap (8) between adjacent fingers on one of the gripper jaws (4) is greater than a width (9) of a corresponding finger on an opposing gripper jaw (4). Functionally, this design dictates the gripping mechanism's ability to accommodate various waveguide sizes and shapes. The specific relationship between the gap (8) and the width (9) ensures that the fingers interlock securely without binding. Implementation involves using CAD software to create a precise 3D model of the gripper jaws (4), specifying the dimensions of the fingers, the gap (8), and the width (9). The benefit of this design is the versatility in clamping different waveguide geometries. Variations could include different finger profiles or the use of compliant materials for enhanced grip.

The process also includes fabricating a mounting surface (1); fabricating a centering mechanism (2) configured to apply force on attached elements in a linear manner; fabricating offset arms (3); and fabricating the gripper jaws (4). Functionally, these steps create the physical components of the mount. “Fabricating” can encompass various manufacturing processes. For the mounting surface (1), this might involve machining a metal plate or molding a polymer component. The centering mechanism (2) could be fabricated by machining components for a screw-driven system or assembling a commercially available vise. The offset arms (3) are typically machined from metal, and the gripper jaws (4) might be machined, 3D printed, or manufactured using other suitable techniques. The benefit of these fabrication steps is the creation of the tangible parts required for the assembly. Variations are numerous, depending on the desired precision, materials, and manufacturing capabilities.

Following fabrication, the process includes attaching the centering mechanism (2) to the mounting surface (1); attaching the offset arms (3) to the centering mechanism (2); and attaching the gripper jaws (4) to the offset arms (3), wherein the gripper jaws (4) are configured with at least one axis of rotation substantially perpendicular to an axis of motion produced by the centering mechanism (2). Functionally, these attachment steps assemble the components into a functional unit. “Attaching” could involve using fasteners (screws, bolts), welding, adhesives, or other joining methods. The critical aspect is the precise alignment and secure connection of the components. The benefit is the creation of a fully functional self-centering clamp. The configuration of the gripper jaws (4) with at least one axis of rotation provides the ability for self-centering. Variations might include different attachment methods or the use of intermediate components for adjustability. The order of attachment steps is generally important for ease of assembly.

Fabricating the mounting surface (1) as an adapter plate for mounting to a robot end effector flange provides a specific interface for robotic applications. Functionally, this allows the self-centering clamp to be easily integrated with automated positioning systems. Implementation involves designing the adapter plate with a bolt pattern or other connection mechanism compatible with standard robotic arm interfaces. The benefit is seamless integration with robotic systems, enabling automated antenna measurements and manipulation.

Minimizing an offset between a pivot location of the gripper jaws (4) and an intersection between gripper planes, during the design of the gripper jaws (4), improves alignment accuracy. Functionally, this reduces any unwanted movement or play in the jaws. Implementation is achieved through careful geometric design in CAD software. The benefit is enhanced precision in the clamping and positioning of the waveguide.

Precision machining, as a fabrication method for the components, ensures high dimensional accuracy and repeatability. Functionally, this is crucial for achieving the precise alignment and self-centering action of the clamp. Implementation involves using CNC milling machines, lathes, or other precision machining equipment. The benefit is the creation of components that meet tight tolerances, ensuring proper function.

Additive manufacturing, as an alternative fabrication method, offers flexibility in design and material selection. Functionally, this allows for the creation of complex geometries that might be difficult to achieve with traditional machining. Implementation could involve using techniques like stereolithography (SLA) or selective laser sintering (SLS). The benefit is the potential for rapid prototyping and the creation of customized designs, although the precision might be lower than that achievable with machining.

Designing a secondary rotation point (12) on each gripper jaw (4), with an axis of rotation perpendicular to the clamping direction, enables the accommodation of tapered waveguides. Functionally, this allows the gripper jaws (4) to conform to the non-uniform shape of tapered waveguides, ensuring a secure grip. Implementation involves incorporating a second pivot point in the jaw design, using pins or other rotational joints. The benefit is increased versatility in handling different waveguide types.

Designing and fabricating, and attaching linear motion constraints (15,17) to the mounting surface (1) and the offset arms (3) adds precision to the movement of the offset arms (3). Functionally, these constraints restrict the motion of the offset arms (3) to a single, well-defined linear path. Implementation involves designing linear rails, guideways, or other linear bearing systems and integrating them into the mount design. These constraints are designed, fabricated, and then attached to the mounting surface (1) and offset arms (3) respectively. The benefits are enhanced alignment accuracy, and reduced play or wobble during clamping.

Attaching the gripper jaws (21) to the offset arms (3) without rotation, in conjunction with linear motion constraints, simplifies the mechanism while maintaining alignment. Functionally, this eliminates the need for rotational joints on the gripper jaws (4), while the linear motion constraints ensure proper alignment. Implementation involves rigidly fixing the gripper jaws (21) to the offset arms (3), possibly using fasteners or welding. The benefit is a simpler and potentially more robust design.

Designing a relief cut (10) between the grippers prevents interference and ensures proper interlocking. Functionally, the relief cut (10) provides clearance for the fingers to move freely without colliding. Implementation is a design consideration incorporated into the CAD model of the gripper jaws (4).

Specifying that the centering mechanism (2) includes opposing screw threads is fundamental to its self-centering action. Functionally, opposing screw threads ensure that as the mechanism is tightened or loosened, the attached components move symmetrically towards or away from a central point. Implementation involves using standard screw threads or designing a custom screw mechanism with opposing threads. The benefit is the inherent self-centering property of the mechanism.

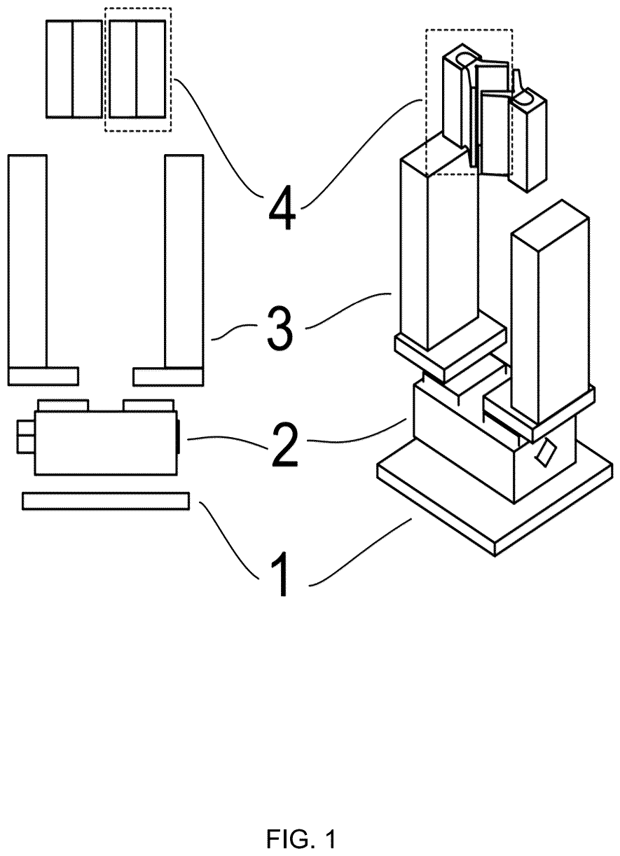

FIG. 1 depicts an embodiment of a self-centering antenna clamp mechanism, illustrating the overall arrangement and interconnection of its primary components. The physical structure is composed of several distinct elements, each contributing to the overall functionality of the device. At the base of the assembly, a mounting surface (1) is visible. This mounting surface (1), shown as a rectangular plate, serves as the foundation for the entire clamp and provides the interface for connecting the clamp to an external positioning system, such as a robotic arm or a test fixture. The mounting surface (1) is shown as a flat plate with a through-hole. Above the mounting surface (1), a centering vise or mechanism (2) is present. This mechanism (2) is responsible for applying a symmetrical clamping force to the antenna waveguide (not shown in this figure). The centering vise or mechanism (2) is depicted as a block-like structure, likely housing a screw-driven system with opposing threads. This design ensures that when the mechanism is actuated, the attached components move equally towards or away from a central point, achieving the self-centering action. The centering mechanism (2) has a bolt and the bolt is located inside the mechanism. Connected to the centering mechanism (2) and extending outwardly are two offset arms (3). These arms, shown as elongated rectangular structures, provide a spatial separation between the centering mechanism (2) and the point where the antenna waveguide will be clamped. The offset arms (3) are oriented vertically in this particular view, and their length determines the maximum size of the waveguide that can be accommodated without interference with the mounting surface (1) or the centering mechanism (2). The offset arms (3) are shown as flat and rectangular.

At the distal ends of the offset arms (3), centering gripper mechanisms (4) are attached. These mechanisms, shown as assemblies with multiple interlocking features, are responsible for directly grasping and holding the antenna waveguide. The gripper mechanisms (4) can have multiple fingers or projections, suggesting their ability to adapt to different waveguide shapes and sizes. The gripper mechanisms (4) are attached to the offset arms (3). The interconnectivity of these elements is pivotal to the operation of the clamp. The mounting surface (1) provides a stable base, the centering mechanism (2) applies the clamping force, the offset arms (3) provide spatial separation, and the gripper mechanisms (4) secure the waveguide. In operation, an antenna waveguide would be placed between the gripper mechanisms (4). The centering mechanism (2) would then be actuated, causing the offset arms (3) and attached gripper mechanisms (4) to move inwards, symmetrically clamping the waveguide. The implementation of this design can involve precision machining of the components from materials such as aluminum or steel to ensure rigidity and accuracy. The benefits of this design include its ability to automatically center waveguides of different sizes, its adaptability to various waveguide geometries, and its potential for integration with automated positioning systems. Variations could include different sizes of the mounting surface (1), different lengths of the offset arms (3), and different configurations of the gripper mechanisms (4) to accommodate specific application requirements. The offset arm (3) length could be anywhere from 1 cm to 50 cm. For instance, the offset arm (3) length can be from 1 cm to 50 cm, specifically from 2 cm to 25 cm, and more specifically from 5 cm to 15 cm. The mounting surface (1) may incorporate different attachment features, such as threaded holes or quick-release mechanisms, to facilitate mounting to various positioning systems. The specific arrangement of interlocking features on the centering gripper mechanism (4) could be modified or customized. An example use case includes using a torque wrench.

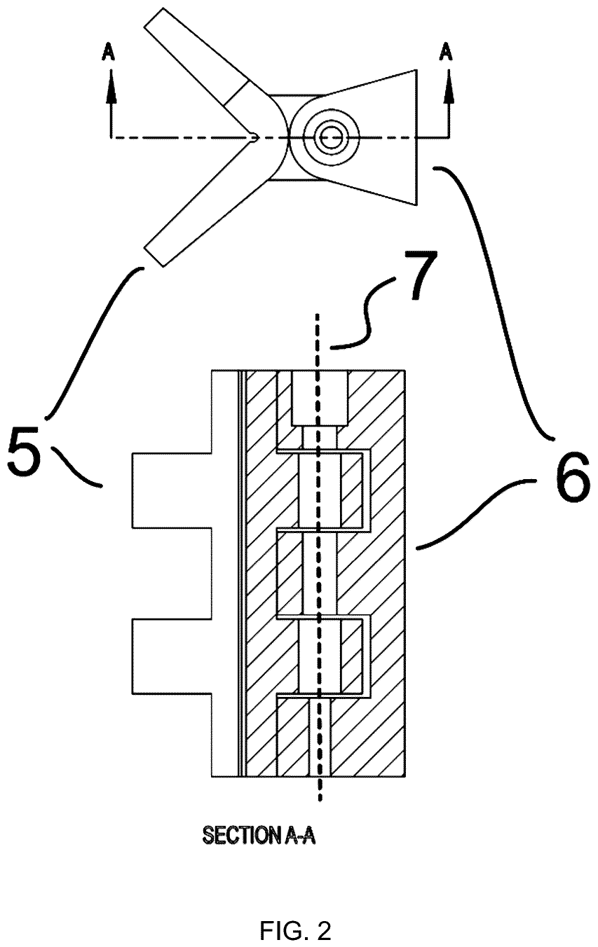

FIG. 2 provides a detailed view of the centering gripper mechanism, a component of the self-centering waveguide clamp antenna mount. The figure shows both a top-down view and a cross-sectional view (labeled “SECTION A-A”), revealing the internal structure and arrangement of the gripper components. The physical structure of the gripper mechanism is characterized by several key elements. Most prominently, gripper fingers (5), shown as elongated, rectangular protrusions, are the elements that directly contact and grip the antenna waveguide. The gripper fingers (5) are arranged in an interlocking pattern. This interlocking design is useful for the gripper's ability to accommodate a range of waveguide sizes and shapes. The gripper fingers (5) are attached to a gripper mounting component (6). This component, shown as a larger, block-like structure, serves as the base for the fingers and provides the connection point to the offset arms (not shown in this figure). The gripper mounting component (6) provides the necessary rigidity and stability for the gripper fingers (5).

A feature of the gripper mechanism is the finger axis of rotation (7). This axis, indicated by a dashed line in the drawing, represents the pivot point around which the gripper fingers (5) rotate. The axis of rotation (7) is oriented perpendicular to the direction of the clamping force. The finger axis of rotation (7) could be from 0.1 mm to 10 mm. The interconnectivity of these elements is useful to the gripper's operation. The gripper fingers (5) are attached to, and rotate around an axis defined relative to, the gripper mounting component (5). This connection allows the fingers to move in a coordinated manner, opening and closing to grip or release the waveguide. The finger gap offset could be from 0.5 mm to 20 mm, specifically from 1 mm to 10 mm, and more specifically 2 mm to 5 mm.

In operation, the gripper mechanism can be actuated by the centering mechanism (not shown in this figure), causing the gripper mounting components (6) to move towards or away from each other. As the gripper mounting components (6) move, the gripper fingers (5), due to their axis of rotation (7), would pivot, either closing to grip a waveguide or opening to release it. The implementation of this design can involve precision machining of the components from materials like aluminum or steel. The finger axis of rotation (7) could be implemented using precision-ground pins or other suitable bearing mechanisms. The benefits of this design include its ability to securely grip waveguides of different sizes and shapes, its self-centering action, and its adaptability to different waveguide orientations. Variations might include different numbers of gripper fingers (5), different finger geometries, or the use of compliant materials on the finger surfaces to enhance grip. An example might involve gripping a rectangular waveguide, where the gripper fingers (5) would engage the sides of the waveguide, and the axis of rotation (7) would allow the fingers to conform to the waveguide's orientation. The interlocking design enables the accommodation of a wide range of sizes of waveguides. The figure also depicts the finger axis of rotation (7), which is critical to the operation. The rotational aspect allows the gripper to adjust to various angles and orientations of the waveguide, further enhancing its flexibility. This adaptability is significant because it allows the mount to accommodate waveguides that may not be perfectly aligned or that have slightly different orientations, without needing manual adjustments.

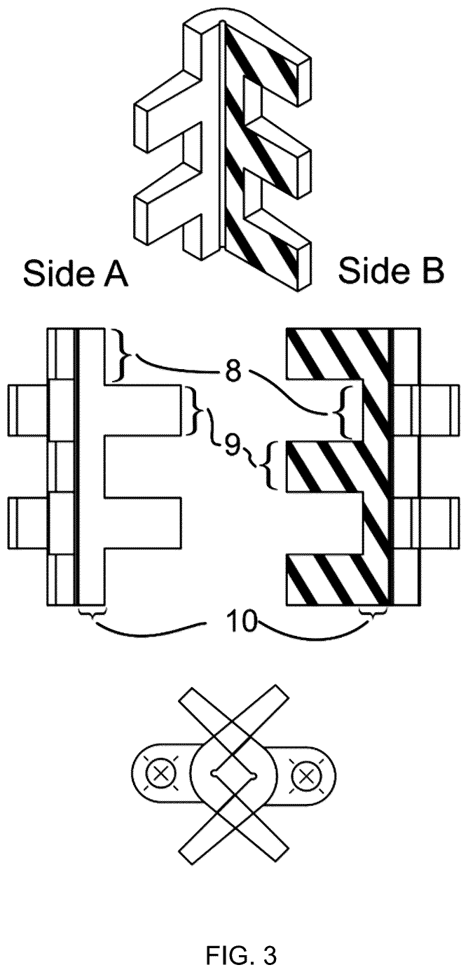

FIG. 3 provides a detailed illustration of the gripper interlocking finger design, a feature of the self-centering waveguide clamp antenna mount. The figure shows multiple views, including isometric, side, and top-down views, to fully elucidate the geometry and arrangement of the fingers. The physical structure of the interlocking fingers is characterized by a series of rectangular protrusions extending from a base (gripper backer). These protrusions, or fingers, are arranged in an alternating pattern, such that the fingers from one gripper jaw interlock with the fingers from the opposing gripper jaw. The finger width (9) can range from 0.05 inches to 0.5 inches, specifically from 0.075 inches to 0.4, and more specifically from 0.1 inches to 0.3 inches. Several dimensions define the geometry of the interlocking fingers. The “Finger Gap Offset Distance” (8) refers to the spacing between adjacent fingers on a single gripper jaw. This distance is critical, as it must be larger than the “Finger Width” (9) of the corresponding fingers on the opposing jaw to allow for proper interlocking. The “Finger Width” (9) is the thickness of each individual finger. The relationship between distance 8 and distance 9 dictates the size and geometry. The “Gripper backer dimension” (10) refers to the thickness of the base from which the fingers extend. This dimension influences the overall strength and rigidity of the gripper. The gripper backer dimension (10) can be from 0.1 inches to 2 inches. Specifically, the gripper backer dimension (10) can be between 0.2 inches and 1 inch, and more specifically, from 0.25 inches to 0.75 inches. The minimum closing distance is dictated by the gripper backer dimension (10).

The interconnectivity of the fingers is useful for their function. When the gripper jaws are closed, the fingers from one jaw mesh with the fingers from the opposing jaw, creating a secure grip on the waveguide. This interlocking action, combined with the centering mechanism, ensures that the waveguide is held firmly and precisely centered. In operation, as the centering mechanism is actuated, the gripper jaws move towards each other, and the interlocking fingers engage the waveguide. The specific geometry of the fingers, with the offset gap (8) and width (9), allows the fingers to accommodate a range of waveguide sizes. The offset allows fingers to interlock with a variety of waveguide sizes and profiles. The implementation of this design can involve precision machining of the gripper jaws from a suitable material, such as aluminum or steel. The dimensions of the fingers, the gap (8), and the width (9) would be carefully controlled to ensure proper interlocking and gripping. The benefits of this interlocking finger design include its ability to securely grip waveguides of different sizes and shapes, its contribution to the self-centering action of the clamp, and its adaptability to various waveguide orientations. This figure helps to illustrate the versatility of the clamp in accommodating different waveguide dimensions. The interlocking nature of the fingers allows for a secure grip, while the offset between the fingers provides the necessary clearance for different waveguide sizes. Variations on the finger geometry could include different shapes or the addition of compliant materials on the finger surfaces. The finger width (9) is important for gripping waveguides. The figure shows Side A and Side B, representing each side of the gripper.

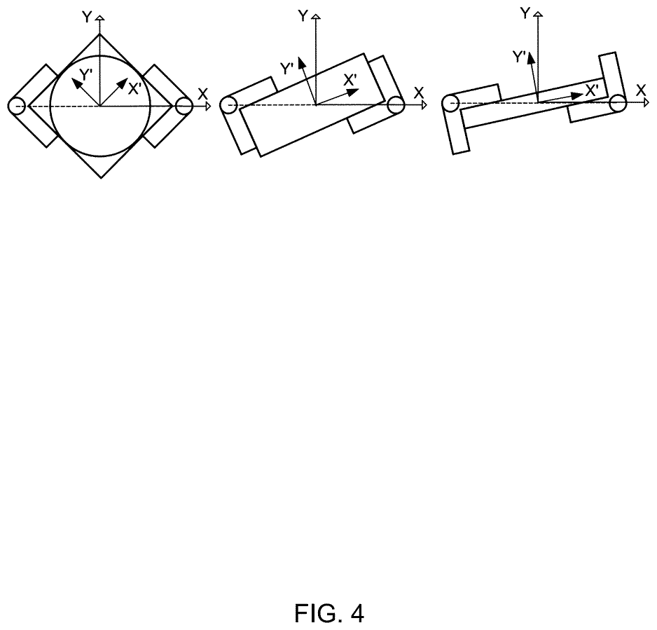

FIG. 4 illustrates the gripper alignment detail for a variety of waveguide profiles, demonstrating the versatility of the self-centering waveguide clamp antenna mount in accommodating different waveguide shapes. The figure shows three different scenarios, each with a different waveguide cross-section: circular, square, and rectangular. The physical structure in each scenario consists of the gripper jaws, represented by simplified rectangular blocks, and the waveguide, represented by the respective geometric shape (circle, square, or rectangle). The gripper jaws are shown in a partially closed position, engaging the waveguide. The important feature to note in the figure includes the contact points between the fingers of the gripper mechanism. The interconnectivity is shown through the engagement of the gripper jaws with the waveguide. The jaws are positioned on opposite sides of the waveguide, applying a clamping force. Although not explicitly shown, the jaws are connected to the offset arms and the centering mechanism, which control their movement. The operability and functionality demonstrated in this figure is the ability of the gripper jaws to maintain Z-axis alignment regardless of the waveguide's cross-sectional shape. In each scenario, the waveguide is centered between the jaws, despite the differences in geometry. This self-centering action is a feature of the embodiment, wherein the mechanism can align the waveguide regardless of shape.

The implementation of this adaptability relies on the design of the gripper jaws, specifically the interlocking finger features and the axis of rotation. The fingers allow the jaws to conform to different shapes, while the axis of rotation allows the jaws to adjust to the orientation of the waveguide. The benefit of this adaptability is significant. It eliminates the need for separate, custom-made fixtures for each waveguide type, saving time and reducing costs in antenna testing and measurement setups. The versatility in accommodating various waveguide profiles without manual adjustments streamlines the workflow, allowing for efficient switching between different antennas or waveguides during testing or calibration procedures. Variations in the gripper jaw design could include different finger geometries or the addition of compliant materials to enhance grip on specific waveguide shapes. The figure also notes that, in this particular version of the mechanism, the rotation induced by the clamping action is not compensated for. This implies that while the waveguide is centered along the Z-axis, there might be a slight rotation around that axis, depending on the waveguide's shape and the clamping force. The examples of use presented in the figure are directly relevant to antenna testing and measurement applications, where different types of antennas, and consequently different waveguide shapes, are frequently encountered. The same clamp may hold square, circular, rectangular, and oval waveguides. The mount can securely clamp waveguides that are from 0.25 inches in diameter to 5 inches in diameter.

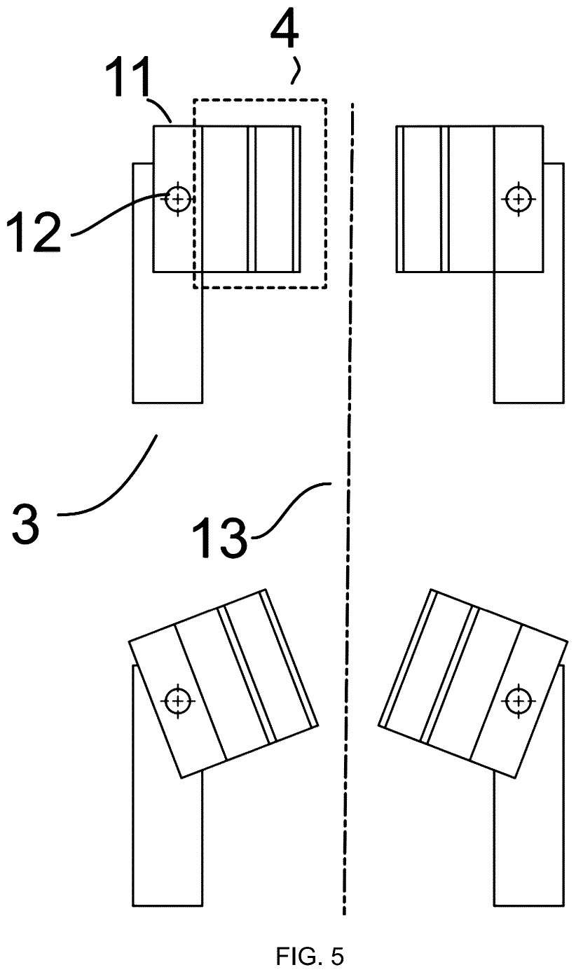

FIG. 5 illustrates a modification to the gripper mechanism designed to support tapered waveguide or antenna profiles. This figure builds upon the previous designs, adding a feature for handling non-uniform waveguide geometries. The physical structure shown in FIG. 5 includes the gripper mechanism (4) from previous figures, which encompasses the interlocking fingers and the primary axis of rotation. However, the key addition is a secondary rotation mount (11), with an axis of rotation perpendicular to the clamping direction. This secondary rotation mount (11) is connected to the original gripper mechanism (4) and introduces a secondary pivot point (12). An offset arm (3) is also depicted. The alignment Z-axis (13) is shown as a dashed line. The interconnectivity is as follows: the original gripper mechanism (4) is attached to the secondary rotation mount (11), which in turn is connected to, likely, the offset arms (although not explicitly shown in this figure, the connection to the rest of the clamp assembly is implied). The secondary pivot point (12) allows the gripper mechanism (4) to rotate independently of the secondary rotation mount (11).

The operability and functionality of this modification are centered around accommodating tapered waveguides. The secondary rotation point (12) allows the gripper jaws to tilt and conform to the angle of the taper, ensuring that the fingers make full contact with the waveguide surface along its length. This is crucial for providing a secure and stable grip on tapered profiles. Without this secondary rotation, the gripper jaws would only make contact at a single point or line, leading to instability and potential slippage. The same angle can exist for both gripper jaws. The implementation of this secondary rotation likely involves precision-machined components and a robust pivot mechanism, such as a pin or bearing, at the secondary pivot point (12). The design must ensure that the rotation is smooth and controlled, while also maintaining the overall rigidity of the clamp. The benefits of this modification are significant, expanding the versatility of the clamp to handle a wider range of waveguide designs, including those commonly used in certain antenna types, such as horn antennas. This eliminates the need for specialized clamps for tapered waveguides. This modification expands the range of applications for the clamp, making it suitable for a broader spectrum of antenna testing and measurement scenarios. The secondary rotation point (12) could be located anywhere from 0.5 inches to 5 inches from the original axis of rotation. Variations could include different mechanisms for achieving the secondary rotation, such as using a ball joint instead of a simple pivot. The angle of the secondary rotation could also be made adjustable to accommodate different taper angles. The figure also depicts the “Alignment Z Axis” (5), highlighting the maintaining of alignment along this axis even with the added rotation. To ensure alignment along the Z-axis (13), both sides of the mount can have the same angle.

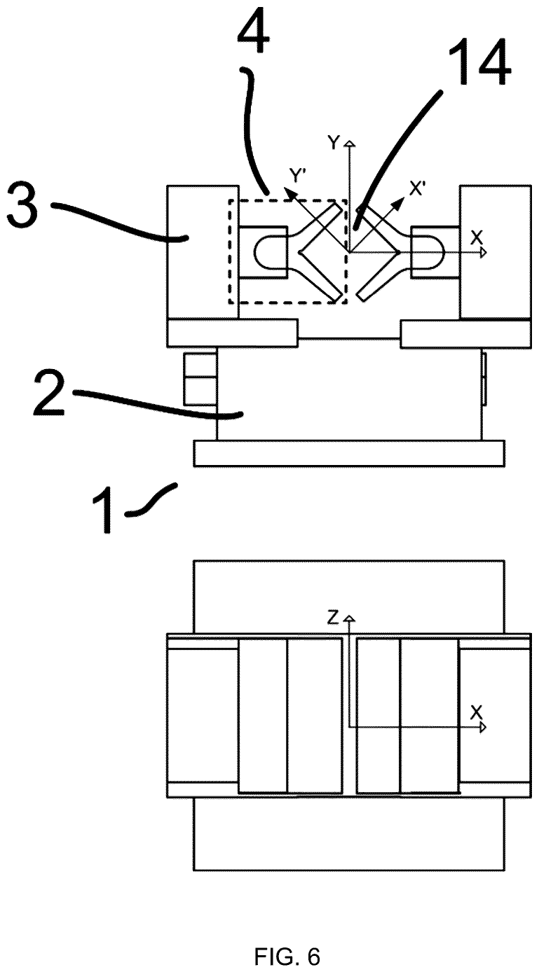

FIG. 6 depicts a horizontal mounting variation of the self-centering waveguide clamp antenna mount. This variation changes the orientation of the gripper mechanism relative to the mounting surface, offering different alignment possibilities. The physical structure shown in FIG. 6 includes various elements: a mounting surface (1), a centering vise or mechanism (2), offset arms (3), and centering gripper mechanisms (4). However, in this configuration, the centering gripper mechanisms (4) are positioned such that their axis of rotation is aligned with the mounting surface (1), rather than perpendicular to it as in previous figures. “Alignment Axes” are indicated, with hollow arrows representing the nominal alignment frame and solid arrows indicating the waveguide alignment for a square profile. The interconnectivity remains similar to the basic design: the mounting surface (1) provides the base, the centering mechanism (2) is attached to the mounting surface (1), the offset arms (3) extend from the centering mechanism (2), and the gripper mechanisms (4) are connected to the offset arms (3). The key difference is the orientation of the gripper mechanisms (4) and their axis of rotation.

The operability and functionality of this horizontal mounting variation differ from the previous configurations. Because the axis of rotation of the gripper mechanisms (4) is parallel to the mounting surface (1), the clamped waveguide will be aligned to an offset location, rather than directly along the mounting surface's Z-axis. This can be advantageous in situations where a specific offset alignment is required. The implementation of this variation involves reorienting the gripper mechanisms (4) during assembly. This might require different offset arms (3) or modifications to the mounting points on the centering mechanism (2). The centering mechanism (2) would still operate in the same way, applying a symmetrical clamping force, but the resulting waveguide alignment would be different. The benefits of this horizontal mounting variation include the ability to achieve offset waveguide alignment, which can be useful in certain antenna testing or measurement setups. This variation expands the range of possible mounting configurations, offering greater flexibility in adapting the clamp to specific application requirements. This provides enhanced versatility. Variations could involve different offset distances, achieved by adjusting the length of the offset arms (3) or the position of the gripper mechanisms (4) on the arms. The angle of the offset could also be made adjustable. The mounting surface (1) area could be from 4 square inches to 100 square inches. Specifically, the mounting surface area could be from 9 square inches to 81 square inches, and more specifically, from 16 square inches to 64 square inches. The figure highlights the “Alignment Axes,” (14) demonstrating how the nominal alignment frame (hollow arrows) differs from the actual waveguide alignment (solid arrows) in this configuration. This difference is a direct consequence of the horizontal mounting orientation of the gripper mechanisms (4). The alignment axes are shown for a square profile.

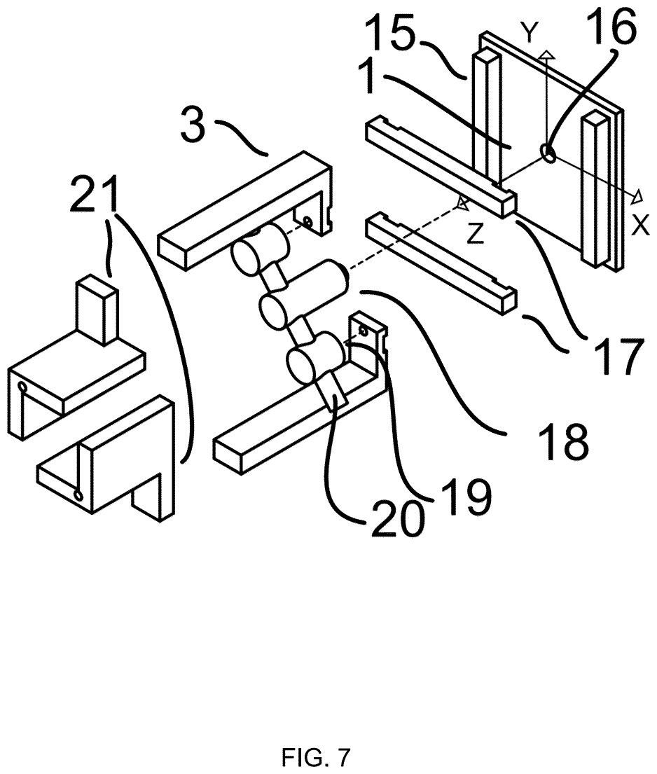

FIG. 7 presents a constrained alignment variation of the self-centering waveguide clamp antenna mount. This variation introduces mechanical constraints to eliminate the angle induced on the clamped waveguide that was observed in conventional designs. The physical structure in FIG. 7 incorporates several new elements. A mounting surface (1) is present, as in previous designs. However, this variation adds a Y linear motion constraint (15), shown as a linear rail, attached to the mounting surface (1). A mounting coordinate system (16) is indicated, establishing a reference frame. An X linear motion constraint (17), also shown as a linear rail, is present, and its orientation suggests it is perpendicular to the Y linear motion constraint (15). Offset arms (3) are connected to the linear motion constraints. A centering screw fixture point (18), which rotates freely around the Z axis of the mounting coordinate system (16) is included. Centering screw interface components (19) are present. A centering screw (20) is shown as part of the assembly. Grippers (21) are attached to the offset arms (3). The interconnectivity involves the mounting surface (1) that provides the base. The Y linear motion constraint (15) is attached to the mounting surface (1), and the X linear motion constraint (17) can be connected to a component that is guided by the Y linear motion constraint (15). The offset arms (3) are connected to the X linear motion constraint (17), allowing them to move along a linear path. The centering screw (20) interacts with the centering screw interface components (19) and the centering screw fixture point (18) to apply the clamping force. The grippers (21) can be statically mounted to the offset arms (3)—that is, without rotation.

The operability and functionality of this constrained alignment variation are centered around eliminating any angular deviation of the clamped waveguide. The linear motion constraints (15 and 17) ensure that the offset arms (3), and therefore the grippers (21), move only along precisely defined linear paths. Because the grippers (21) do not rotate, the waveguide is held without any induced angle, maintaining perfect alignment with the mounting coordinate system (16). The implementation of this design involves precision-machined components and the use of linear rails or other high-precision linear motion components. The centering screw (20) likely has opposing threads, similar to the centering mechanism in previous designs, to ensure symmetrical clamping force. The benefits of this constrained alignment variation are the elimination of any angular deviation in the clamped waveguide and enhanced alignment accuracy. This is particularly important in applications where even slight angular misalignments can significantly impact measurements or system performance. Variations could include different types of linear motion constraints, such as linear bearings or dovetail slides, instead of linear rails. The specific arrangement of the constraints could also be modified. The length of travel of the linear motion constraints could be adjusted to accommodate different waveguide sizes. The length of travel of the Y linear motion constraint (15) can range from 1 inch to 20 inches, more specifically from 2 inches to 15 inches, and most specifically from 3 inches to 10 inches.

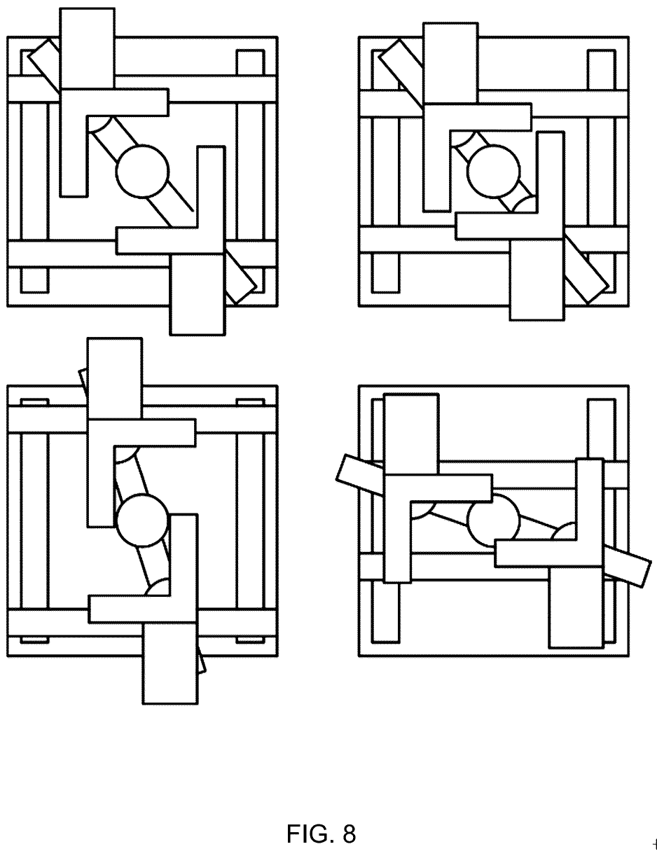

FIG. 8 presents examples of constrained waveguide clamping, demonstrating the ability of the constrained alignment variation (introduced in FIG. 7) to support various waveguide shapes while maintaining precise alignment. The figure shows four different scenarios, each with a different arrangement of the gripper jaws and the waveguide. The physical structure in each scenario includes simplified representations of the gripper jaws, shown as rectangular blocks, and the waveguide, represented by different geometric shapes within the jaws. One aspect is that the gripper jaws are not shown with any rotational features, consistent with the constrained alignment design where the grippers are statically mounted. The arrangement is consistent with FIG. 7. The interconnectivity is implied: the gripper jaws are connected to the offset arms (not explicitly shown in this figure), which in turn are connected to the linear motion constraints and the centering mechanism (also not shown). The movement of the jaws is restricted to a linear path, ensuring that the waveguide is clamped without any induced angle. The operability and functionality demonstrated in this figure is the versatility of the constrained alignment variation in accommodating different waveguide shapes, while maintaining alignment between the waveguide and the mounting coordinate system. Despite the varying geometries of the waveguides, the jaws are able to securely grip them, and the constrained linear motion ensures that the waveguides remain aligned with the reference frame. The figures illustrate alignment.

The implementation relies on the precise design and fabrication of the gripper jaws, the linear motion constraints, and the centering mechanism. The jaws must be designed to provide sufficient contact area and grip for different waveguide shapes, even without rotational features. The linear motion constraints must ensure smooth and precise linear movement, eliminating any play or wobble. The benefits of this constrained alignment, as demonstrated in these examples, are the ability to handle different waveguide geometries while maintaining precise alignment and the elimination of any angular deviation in the clamped waveguide. This is particularly important in applications where alignment accuracy is critical. The clamp is shown to maintain a waveguide's alignment. Variations might involve different gripper jaw designs to optimize grip for specific waveguide shapes. The clamping force could also be adjusted depending on the waveguide material and size. The linear motion mechanism is not shown. The figure shows how waveguides of various cross-sectional profiles could be clamped with this mechanism.

Existing approaches to antenna and waveguide mounting, such as those seen in conventional antenna mounts using threaded rods and interface plates, and even conventional articles such as four-corner picture frame clamps, fundamentally differ from the self-centering waveguide clamp antenna mount in several aspects. The conventional antenna mounts, with their reliance on threaded rods and individual adjustments, lack a mechanism for automatic and precise centering. They require manual manipulation of each standoff to achieve approximate alignment, a process that is inherently time-consuming and prone to inaccuracies. The picture frame clamp, while employing a simultaneous tightening mechanism for four corners, is designed for a completely different application-securing flat, rectangular frames. It lacks the adaptability to accommodate the diverse three-dimensional geometries of waveguides, such as circular, rectangular, or even tapered profiles.

The self-centering waveguide clamp introduces a fundamentally different approach through its combination of a centering mechanism (2), offset arms (3), and gripper jaws (4) with interlocking finger features and at least one axis of rotation. The centering mechanism (2), unlike the simple tightening action of a picture frame clamp or the individual adjustments of threaded rods, ensures symmetrical force application, driving the offset arms (3) and attached gripper jaws (4) towards a precise center point. This centering action is further enhanced by the interlocking finger features of the gripper jaws (4). These features, with their carefully designed gap (8) and width (9), allow the jaws to conform to and securely grip a plurality of waveguide shapes and sizes, a capability absent in both conventional antenna mounts and picture frame clamps. The added axis of rotation on the gripper jaws (7) introduces another level of adaptability, enabling the clamp to accommodate waveguides that are not perfectly aligned or that have varying orientations. The constrained alignment version with linear motion constraints takes it step further.

Furthermore, the option of a secondary rotation point (12) on the gripper jaws (4) specifically addresses the challenge of clamping tapered waveguides, a feature completely absent in existing solutions. The horizontal mounting variation, with its offset alignment capability, and the constrained alignment variation, with its elimination of angular deviation, demonstrate a level of versatility and precision that is simply not achievable with conventional approaches or four corner picture frame clamps. The ability to integrate with robotic systems, through the mounting surface (1) designed as an end effector flange, further distinguishes this approach, enabling automated antenna manipulation and measurement, a capability not inherent in simpler, manual clamping systems.

The articles and processes herein are illustrated further by the following Examples, which are non-limiting.

### EXAMPLE

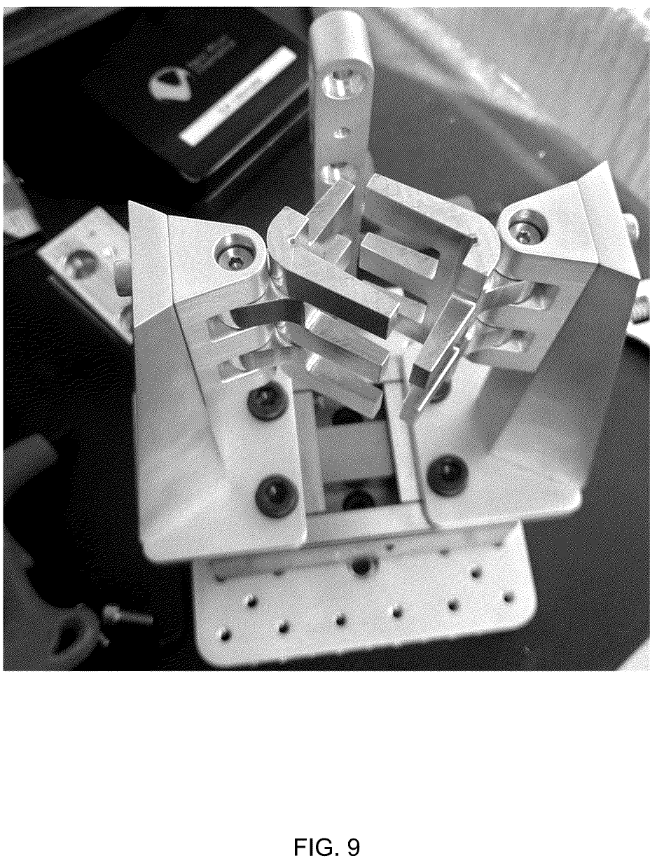

FIG. 9 shows a perspective view of a fully assembled self-centering waveguide clamp antenna mount, configured for vertical centering clamping mechanism placement. This figure provides a practical application, wherein the physical structure is clearly visible, showcasing the various components integrated into a single unit. The mounting plate is shown at the bottom. The centering mechanism sits on the mounting plate. Two offset arms extend upwards, and the complex gripper jaws are at the top of those arms. The interlocking fingers on the grippers are visible. The interconnectivity of the components is shown, wherein the mounting surface provides the foundation. The centering mechanism is mounted on the mounting surface. The offset arms extend vertically from the centering mechanism, and the gripper jaws are attached to the ends of the offset arms. The operability and functionality can be inferred from the assembled view. An antenna waveguide (not shown) would be placed between the gripper jaws. The centering mechanism would then be actuated, causing the offset arms and gripper jaws to move inwards, clamping and centering the waveguide. The vertical orientation of the offset arms suggests that this particular configuration is intended for situations where the waveguide needs to be positioned above the mounting surface.

The implementation can involve precision-machined components, assembled with fasteners or other joining methods. The materials used can be metals, such as aluminum or steel, to ensure rigidity and durability. The specific design of the centering mechanism and the gripper jaws would be as described in previous figures. The benefits of this design, as shown in this assembled view, include its self-centering capability, its adaptability to different waveguide sizes and shapes, and its potential for integration with automated positioning systems (if the mounting surface is designed for such integration). Variations could include different sizes of the mounting surface, different lengths of the offset arms, and different configurations of the gripper jaws. The overall size and proportions of the components could be adjusted depending on the specific application requirements. The vertical arrangement places the waveguide above the mount. The centering mechanism is a vise in this view.

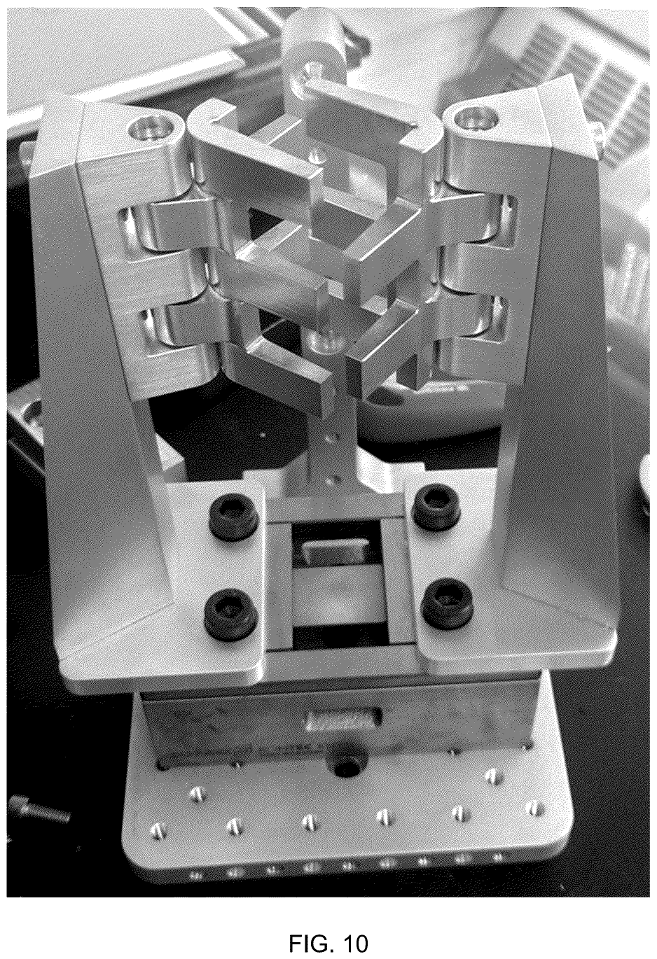

FIG. 10 provides another perspective view of the self-centering waveguide clamp antenna mount for vertical centering clamping, as shown in FIG. 9. This view offers a slightly different angle, allowing for a more complete visualization of the assembled components than FIG. 9. The physical structure is identical to that shown in FIG. 9, with the mounting plate at the base, the centering vise mechanism above it, the two vertical offset arms, and the complex gripper jaws at the top. The interlocking fingers of the gripper jaws are clearly visible from this angle. The centering mechanism is a vise, which is attached to the base. The interconnectivity is the same as described for FIG. 9: the mounting surface provides the foundation, the centering mechanism is mounted on the mounting surface, the offset arms extend vertically from the centering mechanism, and the gripper jaws are attached to the ends of the offset arms. The operability and functionality remain consistent with the description for FIG. 9. An antenna waveguide (not shown) would be placed between the gripper jaws, and the centering mechanism would be actuated to clamp and center the waveguide. The vertical arrangement of the offset arms dictates that this configuration is designed for positioning the waveguide above the mounting surface. The implementation, as in FIG. 9, can involve precision-machined components, assembled with fasteners. The materials can be metals, ensuring rigidity and durability. The specific design details of the centering mechanism and the gripper jaws would correspond to those described in previous figures. The benefits of this design, reiterated in this view, include its self-centering capability, its adaptability to different waveguide sizes and shapes, and its potential for integration with automated positioning systems. The gripper jaws are oriented to open upwards in this view. The grippers can adapt to different sizes. Variations, as mentioned for FIG. 9, could include different sizes of the mounting surface, different lengths of the offset arms, and different configurations of the gripper jaws, depending on the specific application requirements. The overall scale and proportions of the components could be adjusted as needed. This alternate perspective further emphasizes the robust and compact design of the clamp. The vertical offset is more clearly shown.

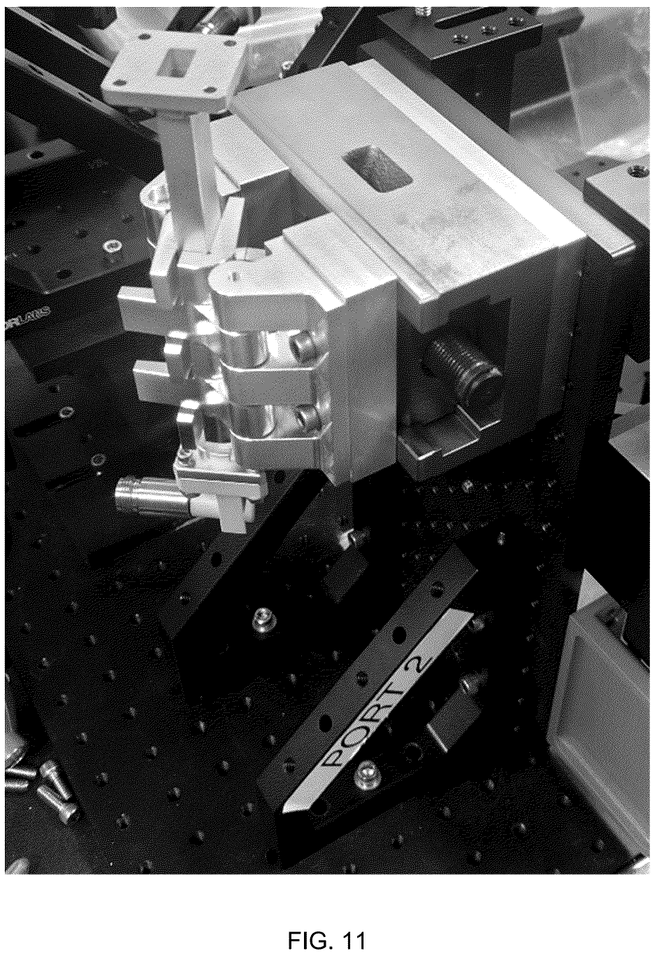

FIG. 11 shows a perspective view of a self-centering waveguide clamp antenna mount configured for horizontal clamping mechanism placement. This figure presents a different orientation of the clamping mechanism compared to FIGS. 9 and 10, offering an alternative mounting configuration. The physical structure, while employing similar components to the vertical configuration, is arranged differently. The mounting plate can be positioned vertically. The centering mechanism can be a vise that extends horizontally from the mounting plate. The offset arms extend outwards, also in a horizontal direction, from the centering mechanism. The gripper jaws are attached to the ends of the offset arms. The gripper fingers are clearly visible clamped around a waveguide. The interconnectivity follows the same general principle as before: the mounting surface provides the base, the centering mechanism is attached to the mounting surface, the offset arms extend from the centering mechanism, and the gripper jaws are connected to the offset arms. However, in this case, both the centering mechanism and the offset arms are oriented horizontally. The operability and functionality are similar in principle to the vertical configuration: an antenna waveguide is placed between the gripper jaws, and the centering mechanism is actuated to clamp and center the waveguide. However, the horizontal arrangement means that the waveguide would be clamped in a plane parallel to the mounting surface, rather than perpendicular to it as in the vertical configuration. The implementation can include precision-machined components and assembly methods similar to the vertical configuration. The materials can be metals for rigidity and durability. The difference is the orientation of the centering mechanism and the offset arms, which might require different mounting features on the mounting surface. The benefits of this horizontal configuration include the ability to clamp waveguides in a different orientation, which might be advantageous in certain testing or measurement setups. This expands the range of possible mounting scenarios, offering greater flexibility in adapting the clamp to specific application requirements. The horizontal configuration allows for a more compact setup in the vertical dimension. Variations can include different lengths of the offset arms, different configurations of the gripper jaws, and different mounting options for the mounting surface. The overall size and proportions of the components could be adjusted as needed. This horizontal arrangement offers an alternative to the vertical configuration, providing flexibility in how the clamp is integrated into a larger system.

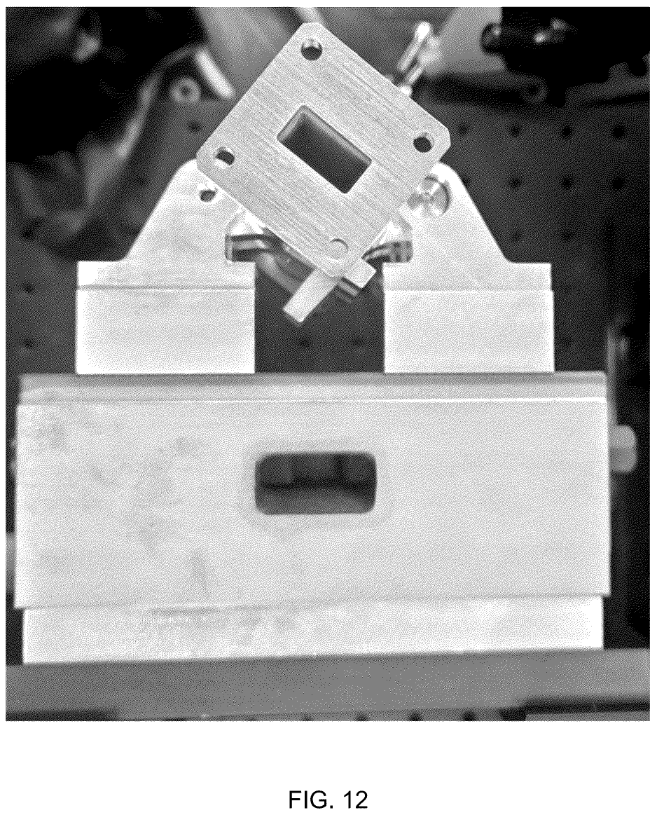

FIG. 12 provides another perspective view of the self-centering waveguide clamp antenna mount configured for horizontal clamping, as previously shown in FIG. 11. This view offers a different angle, allowing for a more complete visualization of the assembled components in the horizontal configuration. The physical structure is identical to that shown in FIG. 11, with the mounting plate appearing to be positioned vertically, the centering vise mechanism and offset arms extending horizontally, and the gripper jaws attached to the ends of the offset arms. The interlocking fingers of the gripper jaws are visible from this perspective. The interconnectivity remains the same as described for FIG. 11: the mounting surface provides the base, the centering mechanism is attached to the mounting surface, the offset arms extend horizontally from the centering mechanism, and the gripper jaws are connected to the offset arms. The operability and functionality are consistent with the description for FIG. 11. An antenna waveguide is be placed between the gripper jaws, and the centering mechanism is actuated to clamp and center the waveguide in a horizontal plane. The implementation, as in FIG. 11, involves precision-machined components and assembly with fasteners. The materials can be metals for rigidity and durability. The key aspect is the horizontal orientation of the centering mechanism and the offset arms, differentiating it from the vertical configurations. The benefits of this horizontal configuration, reiterated in this view, include the ability to clamp waveguides in a plane parallel to the mounting surface, which can be advantageous in certain testing or measurement setups, offering greater flexibility in application. The horizontal configuration offers an alternate method. Variations, as mentioned for FIG. 11, can include different lengths of the offset arms, different configurations of the gripper jaws, and different mounting options for the mounting surface. The overall scale and proportions of the components could be adjusted as needed. This additional perspective further clarifies the spatial arrangement of the components in the horizontal configuration, emphasizing the compact design in the vertical dimension. The centering mechanism is shown to be a vise.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### PARTS LIST

mounting surface 1
centering mechanism 2
offset arms 3
gripper jaws 4
gap 8
width 9
secondary rotation point 12
linear motion constraints 15,17
offset arms 3
gripper jaws no rotation 21

What is claimed is:

1. A self-centering waveguide clamp antenna mount comprising: a mounting surface (1) defining a mounting coordinate system; a centering mechanism (2) coupled to the mounting surface (1), wherein the centering mechanism (2) includes opposing screw threads; offset arms (3) connected to the centering mechanism (2) and extending outwardly therefrom; and gripper jaws (4) connected to the offset arms (3), the gripper jaws (4) having interlocking finger features, wherein the gripper jaws (4) further comprise at least one axis of rotation substantially perpendicular to an axis of motion generated by the centering mechanism (2), and wherein the interlocking finger features of the gripper jaws (4) are adjustably reconfigurable to accommodate a plurality of waveguide geometries and sizes.

2. The self-centering waveguide clamp antenna mount of claim 1, wherein the mounting surface (1) is an end effector flange of a robotic arm.

3. The self-centering waveguide clamp antenna mount of claim 1, wherein the centering mechanism (2) is a vise.

4. The self-centering waveguide clamp antenna mount of claim 1, wherein the offset arms (3) are machined plates.

5. The self-centering waveguide clamp antenna mount of claim 1, wherein the gripper jaws (4) comprise a plurality of interlocking fingers, and wherein a gap (1) between adjacent fingers on one of the gripper jaws (4) is larger than a width (2) of a corresponding finger on an opposing gripper jaw (4).

6. The self-centering waveguide clamp antenna mount of claim 1, wherein the gripper jaws (4) are configured to grasp waveguides having rectangular, square, circular, or oval cross-sectional shapes.

7. The self-centering waveguide clamp antenna mount of claim 1, wherein the gripper jaws (4) further include a secondary rotation point (12) configured to accommodate tapered waveguide profiles, wherein an axis of rotation of the secondary rotation point (12) is perpendicular to a clamping direction of the gripper jaws (4).

8. The self-centering waveguide clamp antenna mount of claim 1, wherein the at least one axis of rotation of the gripper jaws (4) is aligned with the mounting surface (1).

9. The self-centering waveguide clamp antenna mount of claim 1, further comprising: linear motion constraints (15,17) coupled to the mounting surface (1) and the offset arms (3) respectively, the linear motion constraints (15,17) configured to restrict movement of the offset arms (3) to a linear path; and wherein the gripper jaws (21) are statically mounted to the offset arms (3) without rotation.

10. The self-centering waveguide clamp antenna mount of claim 9, wherein the linear motion constraints are linear rails (15,17).

11. A process for self-centered clamping of an antenna waveguide with a self-centering waveguide clamp antenna mount, the process comprising: providing a self-centering waveguide clamp antenna mount, the mount comprising: a mounting surface (1); a centering mechanism (2) coupled to the mounting surface (1); offset arms (3) connected to the centering mechanism (2); and gripper jaws (4) connected to the offset arms (3), the gripper jaws (4) having interlocking finger features; opening the centering mechanism (2) to rotate the gripper jaws (4) and create a space for receiving an antenna waveguide; inserting the antenna waveguide into the space between the gripper jaws (4); and closing the centering mechanism (2) to clamp the antenna waveguide with the gripper jaws (4), wherein the interlocking finger features of the gripper jaws (4) center the antenna waveguide along a desired axis.

12. The process of claim 11, wherein the mounting surface (1) is an end effector flange of a robotic arm.

13. The process of claim 11, further comprising characterizing a length offset of a device under test (DUT) when a Z reference collar is used.

14. The process of claim 11, further comprising mechanically abutting a Z reference collar of the antenna waveguide to the self-centering waveguide clamp antenna mount.

15. The process of claim 11, further comprising characterizing a Z offset between a coordinate system of a device under test (DUT) and a coordinate system of a motion platform when a Z reference collar is not used.

16. The process of claim 11, wherein closing the centering mechanism (2) comprises applying a predetermined clamping force using a torque wrench.

17. The process of claim 11, wherein the gripper jaws (4) further include a secondary rotation point (12), and the process further comprises adjusting the secondary rotation point (12) to accommodate a tapered profile of the antenna waveguide.

18. The process of claim 11, wherein the self-centering waveguide clamp further comprises linear motion constraints (15,17), and wherein closing the centering mechanism (2) comprises moving the offset arms (3) along a linear path defined by the linear motion constraints (15,17).

19. The process of claim 11, wherein opening the centering mechanism (2) includes rotating the gripper jaws (4) upward.

20. The process of claim 11, further comprising: mounting the self-centering waveguide clamp antenna mount to an antenna positioning system prior to opening the centering mechanism (2).
